(19) United States
(12) Patent Application Publication
(10) Pub. No.: US 2004/0086260 A1
(43) Pub. Date: May 6, 2004

(54) Method for registering identifier

(76) Inventor: Chang-Min Kwak, Seoul (KR)

Correspondence Address: BIRCH STEWART KOLASCH & BIRCH, PO BOX 747, FALLS CHURCH, VA, 22040-0747, US

(21) Appl. No.: 10/646,749

(22) Filed: Aug. 25, 2003

(30) Foreign Application Priority Data
Oct. 22, 2002 (KR) 64679/2002

(51) Int. Cl. H04N 5/76

(52) U.S. Cl. 386/46; 386/83

(57) ABSTRACT

Disclosed is a method for registering an identifier, which can stably and effectively perform a broadcasting channel management by registering a user's photo image in a memory of a digital video device as an identifier. To this end, the method comprises the steps of: recording an image in a storing unit of a digital video device as an identifier; and managing channels of the digital video device on the basis of the image identifier.

### BACKGROUND OF THE INVENTION

1. Field of the Invention

The present invention relates to a digital video device, and more particularly, to a method for registering an identifier to a video device such as a digital television, a set-top box, a plasma display panel, and etc.

2. Description of the Related Art

Generally, in a digital device such as a set-top box (STB), a plasma display panel (DTV), and etc., characters are registered as a user's identifier, channels are registered by a user's preference, and the registered channels can be conveniently selected by a user corresponding to the identifier. Herein, the user's identifier ID is recorded in a storing unit of the digital video device.

For example, a method for registering an identifier in a digital video device in accordance with the conventional art comprises the steps of: setting a mode for registering user's preference channels; displaying a dialogue box for inputting characters as an identifier on a screen of the video device if the mode is set; and registering inputted characters as an identifier if characters desired by the member are inputted to the displayed dialogue box.

Also, the conventional method for registering an identifier in a digital video device further comprises the steps of: displaying a channel list for selecting preference channels at the time of registering preference channels under a state that the identifier is registered; and if a number of the user's preference channel is inputted on the channel list, recording the inputted channel number in a corresponding memory region with the registered identifier. That is, the registered identifier includes the channel number inputted by the user. Hereinafter, the conventional method for registering an identifier in a digital video device will be explained with reference to FIGS. 1 and 2.

FIG. 1 is a view showing a dialogue box for inputting an identifier in accordance with the conventional art. That is, FIG. 1 is a view showing a dialogue box for inputting characters into a digital video device as an identifier.

FIG. 2 is a view showing a preference channel list in accordance with the conventional art.

First, when user's preference channels are to be registered in a digital video device such as the DTV, the user sets a mode for registering the preference channels. At this time, if the mode is set, an inner microprocessor of the DTV displays a dialogue box on a screen as shown in FIG. 1.

If the user inputs desired characters (identifiers) into the dialogue box, the DTV registers the inputted characters as an identifier and then displays a channel list for registering the user's preference channels on the screen. Also, if the user inputs specific channels on the channel list, the inputted specific channels are registered.

As shown in FIG. 2, the channel list is composed of identifiers registered by each user and a channel list recorded by corresponding to the respective identifiers. That is, the channel list includes channel numbers and character identifiers registered by each user.

In the meantime, in the conventional DTV, the user registers his own family ID, allocates a peculiar region of a corresponding identifier, and registers preference channels or paper per view (PPV) channels, and etc. to the allocated peculiar region. Also, in the conventional DTV, a specific administrator can be registered and entire system functions, for example, a function to shield harmful channels, can be performed by an instruction of the specific administrator.

However, in the conventional method for registering an identifier to a digital video device, the user (for example, family members) registers only his desired identifiers. According to this, even if a child under age registers the identifiers and then registers harmful channels, a member of the identifiers can not be immediately and correctly distinguished thus to have a difficulty in managing preference channels. That is, in the conventional method for registering an identifier to a digital video device, the child under age registers identifiers and then registers harmful channel numbers to a channel list corresponding to the identifiers, thereby watching a broadcasting program corresponding to the harmful channels. Also, in the conventional method, parents can not correctly distinguish their child's identifiers, for example, Tom's identifiers, thus they may register channels showing broadcasting programs forbidden to children under age to the child's identifiers.

### SUMMARY OF THE INVENTION

Therefore, an object of the present invention is to provide a method for registering an identifier which can conveniently and correctly distinguish a family member by using images.

Another object of the present invention is to provide a method for registering an identifier, which can stably and effectively manage channels by registering an identifier which can distinguish each family member simply and correctly by using photo images.

Still another object of the present invention is to provide a method for registering an identifier, which can stably and effectively manage preference channels by registering family members' photo images as an identifier.

To achieve these and other advantages and in accordance with the purpose of the present invention, as embodied and broadly described herein, there is provided a method for registering an identifier comprising the steps of: recording images in a storing unit of a digital video device as an identifier; and managing channels of the digital video device on the basis of the image identifier.

To achieve these and other advantages and in accordance with the purpose of the present invention, as embodied and broadly described herein, there is also provided a method for registering an identifier comprising the steps of: displaying images on a screen of a digital video device; and registering an image selected by a user among the displayed images as an identifier.

To achieve these and other advantages and in accordance with the purpose of the present invention, as embodied and broadly described herein, there is still also provided a method for registering an identifier comprising the steps of: connecting a memory card where photo images are recorded to a digital video device; displaying images recorded in the memory card on a screen of the digital video device; registering an image selected by a user among the displayed images as an identifier; displaying the image identifier and a channel input item corresponding to the image identifier on the screen; and registering inputted preference channels when a user's preference channels are inputted to the channel input item.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a dialogue box for inputting an identifier in accordance with the conventional art;

FIG. 2 is a view showing a preference channel list in accordance with the conventional art;

FIG. 3 is a flow chart showing a method for registering identifiers and preference channels;

FIG. 4 is a view showing that images recorded in a memory card are displayed on a screen of a DTV;

FIG. 5 is a view showing a channel edition list according to the present invention;

FIG. 6 is a view showing a preference channel list according to the present invention;

FIG. 7 is a view showing a dialogue box for inputting character identifiers according to the present invention; and

FIG. 8 is a view showing a channel edition list including character identifiers, image identifiers, and preference channels according to the present invention.

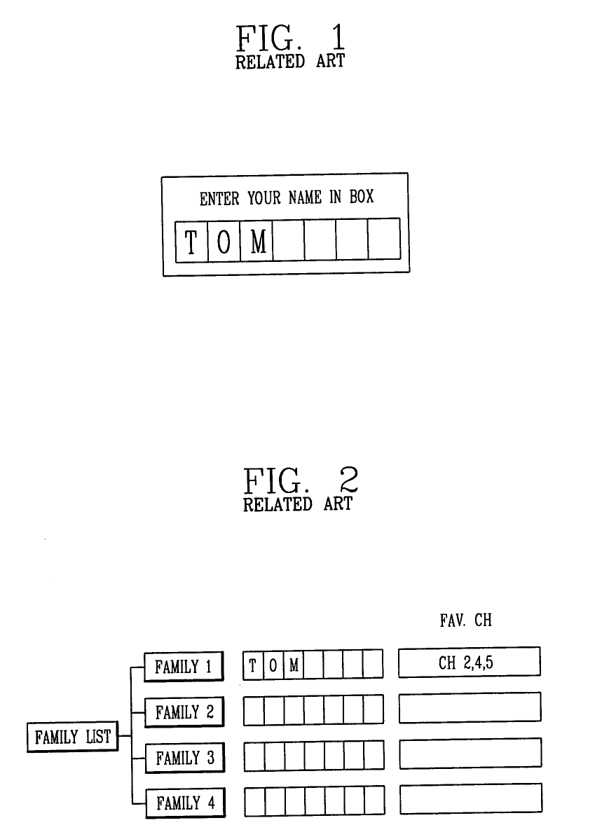

### DETAILED DESCRIPTION OF THE PREFERRED EMBODIMENTS

Reference will now be made in detail to the preferred embodiments of the present invention, examples of which are illustrated in the accompanying drawings.

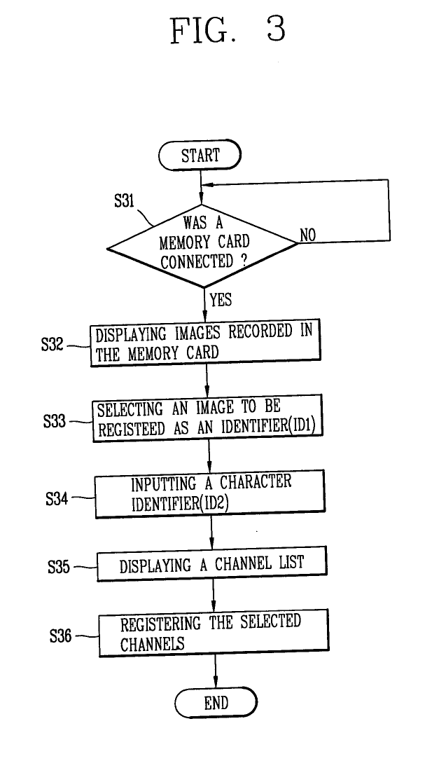

Hereinafter, a method for registering an identifier, which can stably and effectively manage broadcasting channels by recording a user's (for example, a family member) photo images in a memory of the digital video device as an identifier will be explained with reference to FIGS. 3 to 8 in detail. Also, in the present invention, a video device having a preference channel registration function is supposed as a DTV, and the DTV is supposed to have a memory card mounting device. That is, the video device such as the DTV, a STB, a PDP, and etc. includes a connecting device (connector) connected to a digital camera or a camcorder and capable of mounting a memory card.

FIG. 3 is a flow chart showing a method for registering identifiers and preference channels.

As shown in FIG. 3, the method for registering identifiers and preference channels comprises the steps of: connecting a memory card where images (for example, family members' photo images) are recorded to a digital video device S31; displaying images recorded in the memory card on a screen by performing a photo album program pre-installed in the digital video device S32; if images desired by the first family member (for example, the first family member's portraits) are selected among the images displayed on the screen S33, registering the selected image as an identifier ID1 and adding a character identifier ID2 S34; displaying a channel list for selecting channels on the screen if the image identifier ID1 or the character identifier ID2 are registered S35; and registering the selected preference channels with the image identifier ID1 and the character identifier ID2 if the first family member's preference channels are selected on the displayed channel list S36. That is, in the present invention, preference channels can be registered to a channel input list corresponding to the image identifier ID1, and if the preference channels are selected by the first family member, the first family member can watch broadcasting programs corresponding to the selected preference channels.

Also, in the present invention, family members can be correctly distinguished by the identifiers ID1 and ID2, channels of the digital video device can be stably and effectively managed, and a watching right of a specific channel can be provided by the image identifier ID1. For example, if parents register a channel 6 of a DTV and channels 2 and 7 of a general TV to a channel input list corresponding to TOM's image identifier (TOM is a child under age), said TOM can watch only the channels 6, 2, and 7 registered by his parents.

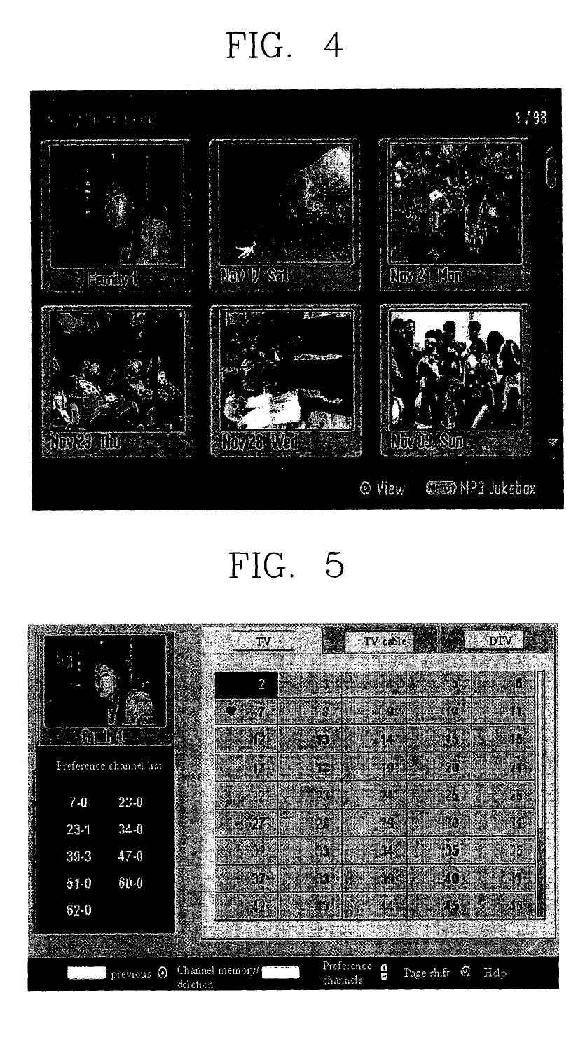

The method for registering identifiers and preference channels according to the present invention will be explained with reference to FIGS. 4 to 8 in detail. Herein, the DTV includes a component which can display images recorded in a memory card by a photo album program as an ‘on screen display’ (OSD) form on a screen of the DTV. The component corresponds to the conventional art, thus its explanation will be omitted.

First, if the user (the first family member) mounts a memory card (not shown) to a memory card connector of a DTV (not shown) S31, the DTV displays images recorded in the memory card on a screen of the DTV. That is, if the user selects images recorded in the memory card by performing a photo album program installed in a hard disc of the DTV by using a remote controller (not shown) or a key pad (not shown), the DTV displays the selected images on the screen of the DTV S32. The images displayed on the screen of the DTV will be explained with reference to FIG. 4 in detail.

FIG. 4 is a view showing that images recorded in a memory card are displayed on a screen of a DTV. That is, if imaged desired to be registered as an identifier by the user do not exist among images displayed on the screen of the DTV, the user (for example, a family member) displays next images recorded in the memory card on the screen the DTV by using a remote controller or a key pad.

Next, if an image (family 1) desired by the user is displayed on the screen of the DTV and the user selects the image referred as the family 1 (highlighted image) and then presses a specific key such as an enter key, the DTV records and registers the image referred as the family 1 to a corresponding memory region as an image identifier ID1. At this time, the image selected as the image identifier ID1 is edited by the photo album program thus to be recorded in the corresponding memory region. Herein, it is preferable that a portrait of the family member is registered as the image identifier ID1 S33.

If the desired image is registered as the image identifier ID1, the DTV displays a channel list for selecting channels on the screen thereof. The channels correspond to an analogue TV broadcasting, a digital TV broadcasting, and a cable TV broadcasting, and are displayed on the screen as an ‘OSD’ form S35. If the family member selects preference channels on the displayed channel list, the selected preference channels are recorded and registered to a corresponding memory region of the DTV with the identifier ID1 S36. Also, the DTV displays a channel edition list for editing the channel list on the screen by the user's request. The channel edition list will be explained in detail with reference to FIG. 5.

FIG. 5 is a view showing a channel edition list according to the present invention.

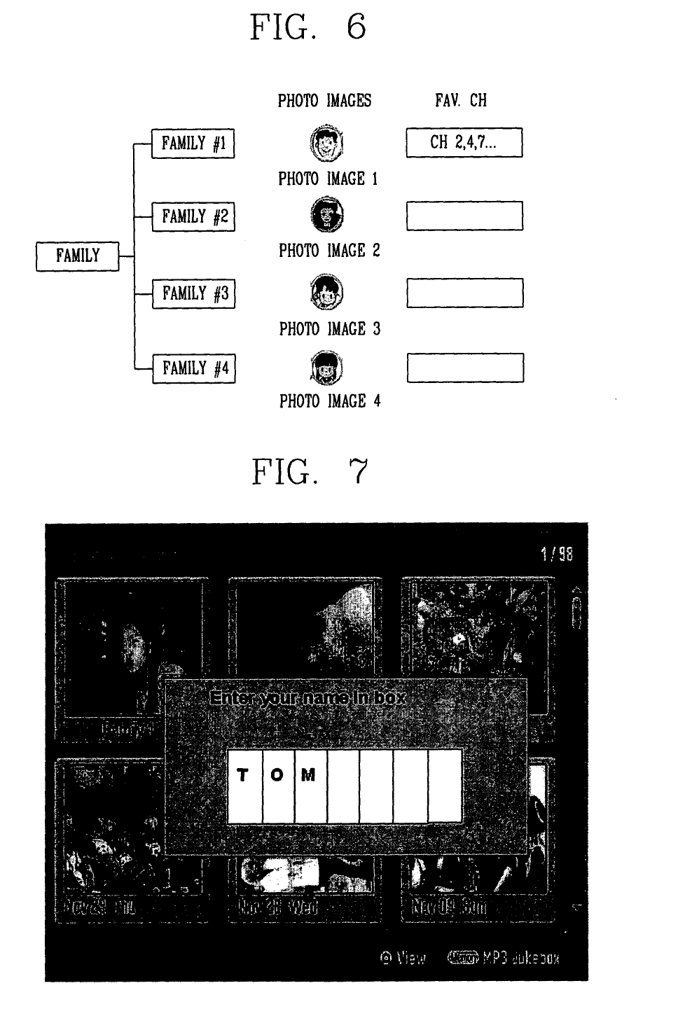

As shown in FIG. 5, a channel edition list including the preference channels and the image identifier (family member's photo images) are displayed on the screen so that an arbitrary member, especially a member defined as a manager, can easily distinguish who has registered the preference channels. Also, if preference channels are selected on the displayed channel edition list by using a remote controller or a key pad, a microprocessor in the DTV records and registers the selected preference channels to a corresponding memory region. A preference channel list displayed on the screen when the identifier and the preference channels are registered will be explained with reference to FIG. 6 in detail.

FIG. 6 is a view showing a preference channel list according to the present invention.

As shown in FIG. 6, the preference channel list is constituted with identifiers ID1 (photo image 1, photo image 2, photo image 3, . . . ) registered according to each family member (family #1, family #2, family #3, . . . ) and preference channels (ch 2, 4, 7, . . . ) recorded correspondingly said each identifier ID1. That is, the preference channel list is displayed on the screen when the identifier (for example, photo image 1) and the preference channels (ch 2, 4, 7, . . . ) corresponding to the photo image 1 are registered.

In the meantime, in the preferred embodiments of the present invention, if a specific image is selected as an image identifier among the displayed images of FIG. 4, a dialogue box is displayed on the images. The dialogue box will be explained in more detail with reference to FIG. 7.

FIG. 7 is a view showing a dialogue box for inputting character identifiers according to the present invention. That is, if the family member selects a specific image as an image identifier, a corresponding member displays the dialogue box for inputting characters as a second identifier ID2 on the screen. Herein, if characters corresponding to the second identifier ID2 are inputted into the dialogue box S34, the DTV records and registers the second identifier ID2, the first identifier ID1, and the preference channels corresponding to the first identifier ID1 into a corresponding memory region of the DTV.

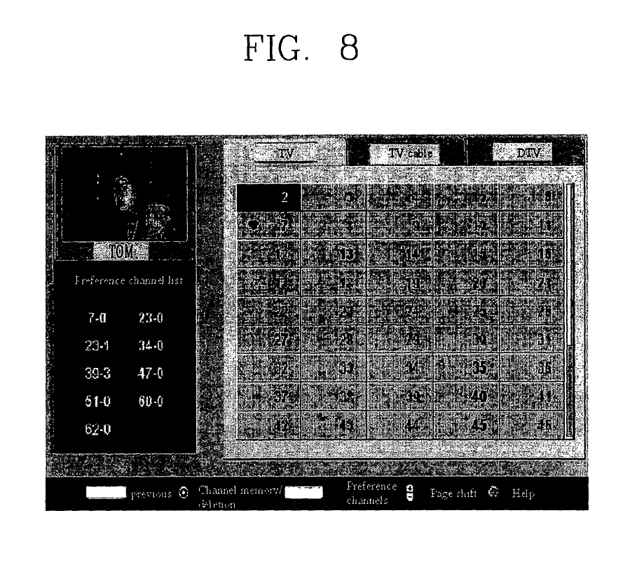

Subsequently, if the family member selects the channel edition list in order to edit previously registered preference channels, the selected channel edition list is displayed on the screen. The channel edition list will be explained with reference to FIG. 8 in detail.

FIG. 8 is a view showing a channel edition list including character identifiers, image identifiers, and preference channels according to the present invention. Herein, the channel edition list of FIG. 8 is constituted with the channel edition list of FIG. 5 and the character identifier ID2 (TOM).

As shown in FIG. 8, the channel edition list including the second identifier ID2, the first identifier ID1, and numbers of preference channels corresponding to the first identifier ID1 is displayed on the screen by the user's request. That is, if the family member inputs his preference channels on a channel input item of the channel edition list again, the DTV records and registers numbers of the re-inputted preference channels into a corresponding memory region with the second identifier ID2 and the first identifier ID1. Accordingly, each family member can correctly distinguish his own identifier by the first identifier ID1 and the second identifier ID2, and can correctly register his preference channels to a channel input item corresponding to his own identifier.

As aforementioned, in the present invention, images are registered as an identifier, so that each member can be distinguished simply and correctly.

Also, in the present invention, photo images are registered as an identifier, so that channels can be stably and effectively manages. That is, by registering photo images of each family member as an identifier, preference channels can be managed stably and effectively.

Besides, in the present invention, photo images of the first family member are registered as an identifier of a member who has registered specific channels, so that the second family member can easily and correctly distinguish the first family member who has registered the specific channels.

Also, in the present invention, by registering photo images of family members as an image identifier of a member who has registered specific channels, a member who has registered the specific channels can be easily and correctly distinguished. According to this, an indiscreet channel registration and a harmful channel registration can be prevented. For example, in the present invention, parents can correctly distinguish a child under age, for example, TOM's image identifier, so that a channel of a broadcasting program forbidden to a child under age can be correctly registered to a channel input item corresponding to parents' identifiers not the child's identifier. Besides, in the present invention, parents correctly distinguish their child's image identifier thus to correctly register instructive channels to a channel input item corresponding to their child's identifier.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for registering an identifier comprising the steps of:
recording images in a storing unit of a digital video device as an identifier; and
managing channels of the digital video device on the basis of the recorded image identifier.

2. The method of claim 1, further comprising a step of recording characters in the storing unit of the digital video device as an identifier.

3. The method of claim 2, further comprising a step of registering preference channels selected by a user to a list for inputting channels corresponding to the image identifier and the characters identifier.

4. A method for registering an identifier comprising the steps of:
displaying images on a screen of a digital video device; and
registering an image selected by a user among the displayed images as an identifier.

5. The method of claim 4, wherein the step of displaying images comprises the steps of:
connecting a memory card where photo images are recorded to the digital video device; and
displaying images recorded in the memory card on the screen of the digital video device.

6. The method of claim 4, further comprising the steps of:
registering the identifier and then displaying a list for selecting preference channels on the screen; and
registering preference channels selected by a user corresponding to the image identifier.

7. The method of claim 6, wherein the list for selecting preference channels is displayed on the screen as an ‘On Screen Display’ form.

8. The method of claim 4, further comprising a step of registering the image as a first identifier and then registering characters as a second identifier.

9. The method of claim 4, wherein the identifier is images for managing channels of the digital video device and endowing a watching right of specific channels.

10. The method of claim 4, wherein the identifier is images for distinguishing family members.

11. The method of claim 4, wherein the identifier is photo images of family members.

12. A method for registering an identifier comprising the steps of:
connecting a memory card where photo images are recorded to a digital video device;
displaying images recorded in the memory card on a screen of the digital video device;
registering an image selected by a user among the displayed images as an identifier;
displaying the image identifier and a channel input item corresponding to the image identifier on the screen; and
registering inputted preference channels when a user's preference channels are inputted to the channel input item.

13. The method of claim 12, wherein the step of registering preference channels comprises the steps of:
displaying channels corresponding to an analogue TV broadcasting, a digital TV broadcasting, and a cable TV broadcasting on the screen as an ‘On Screen Display’ form; and
registering preference channels selected by the user to the channel input item if the user selects preference channels among the channels.

14. The method of claim 12, further comprising a step of registering the image identifier and additionally registering a character identifier.

15. The method of claim 12, wherein the identifier is images for managing channels of the digital video device and endowing a watching right of specific channels.

16. The method of claim 12, wherein the identifier is images for distinguishing family members.

17. The method of claim 12, wherein the identifier is photo images of family members.
